(19) United States
(12) Patent Application Publication
(10) Pub. No.: US 2016/0336768 A1
(43) Pub. Date: Nov. 17, 2016

(54) METHOD AND SYSTEM FOR MANAGING A PLURALITY OF ENERGY STORAGE ASSEMBLIES

(71) Applicant: BLUE SOLUTIONS, Ergué Gabéric (FR)

(72) Inventors: Yvon LE PAVEN, Ergue Gaberic (FR); Gilles BRUNET, Ploneis (FR); Christian SELLIN, Concarneau (FR); Jean-Jacques JESTIN, Fouesnant (FR)

(21) Appl. No.: 15/111,786

(22) PCT Filed: Jan. 16, 2015
(86) PCT No.: PCT/EP2015/050736

§ 371 Date: Jul. 14, 2016

(30) Foreign Application Priority Data
Jan. 17, 2014 (FR) 1450394

(51) Int. Cl. H02J 7/00; H02J 3/38

(52) U.S. Cl. CPC H02J 7/0024; H02J 7/0063; H02J 3/382; H02J 2007/0067

(57) ABSTRACT

The invention is aimed at a method of managing a plurality of energy storage assemblies (18A-18C, 20) intended to provide the electrical energy to an object to be powered (16) during a discharge phase, the storage assemblies being linked electrically in parallel, at least one DC current converter (22, 24) being interposed between the energy storage assemblies and the object to be powered, so that the energy originating from each storage assembly is converted in a manner independent of that originating from the other assemblies, the method being characterized in that during the discharge phase: at least one parameter relating to each storage assembly is measured, as a function of the parameters measured for all the assemblies and of at least one output power relating to the object to be powered, there is determined for the or each converter at least one setpoint relating to a respective electrical quantity at output, so that a distinct setpoint is associated with each of the assemblies, the converter or converters is or are controlled so that the corresponding setpoint is applied. The invention is also aimed at a system allowing the application of the method according to the invention.

The invention relates to a system for powering an object, by means of a plurality of power storage assemblies and in particular a management method for providing power by these storage assemblies.

Power storage assemblies are already known, especially batteries, connected in series or in parallel and intended to supply an object, one or more DC converters being placed between these storage assemblies and the object to be supplied. Power is transferred if needed from the storage assemblies to the object to be supplied, according to the needs of the object. The power originating from the assemblies being generally converted uniformly for all the assemblies, the assemblies being controlled to provide power uniformly to the object to be supplied.

Such a relatively classic supply system generally gives satisfaction. However, in some cases, especially when a large number of power storage assemblies is used, for example for a powering a plurality of residences, it is evident that the service life of each of the assemblies in the system is not as long as when the assemblies are used individually.

The aim of the invention is to improve the service life of a system for providing power such as described above.

For this purpose, the aim of the invention is a method for managing a plurality of power storage assemblies intended to provide electric power to an object to be supplied during a discharge phase, the storage assemblies being electrically connected in parallel, at least one DC converter being interposed between the power storage assemblies and the object to be supplied, such that the power originating from each storage assembly is converted independently of that originating from the other assemblies, wherein, during the discharge phase:
at least one parameter relative to each storage assembly is measured,
as a function of the parameters measured for all the assemblies and of at least one output power relative to the object to be supplied, at least one setpoint relative to an electrical magnitude respective at output is determined for said or each converter, such that a separate setpoint is associated to each of the assemblies,
the converter(s) are controlled so that the corresponding setpoint is applied.

In this way, given the needs of the object to be supplied, operation of the system is adapted given any specificities of each storage assembly. Each of the assemblies used for powering the object is in fact managed in a personalized way, and the service life of each of the assemblies is optimized, also boosting the service life of the system.

In fact, it is common for two storage assemblies not to have quite the same behavior as one operation. These minor differences, when the assemblies leave the assembly lines can grow after a certain number of operating cycles, causing degradation of one of the assemblies. This degradation can engender operating in overdrive for the other assemblies which can degrade more rapidly than when they work in isolation. The invention rectifies this drawback, especially given the parameters of all the assemblies and not only those of the assembly concerned for determining the setpoint of the converter associated to the assembly.

The invention therefore provides a system for supplying power whereof the service life is greater than this which is obtained in the prior art. It accordingly also boosts dispersions of characteristics of assemblies selected to constitute the system, these dispersions no longer being problems, even if the assemblies work together.

The method according to the invention can comprise the one or more characteristics of the following list:
as a reminder, the setpoint at output of the converter is the imposed value of an electrical magnitude (especially voltage or current) at the converter;
a separate converter can be associated to each storage assembly. As a variant, the same converter can be associated to several storage assemblies. Said converter comprises several electrical branches in parallel each connected to a storage assembly and adjusting means of the electrical magnitude (IGBT type for example) by electrical branch. It is also evident however that if a converter is electrically connected to several storage assemblies, these assemblies can either all operate in the same mode (charge or discharge), or independently of each other. This last embodiment allows good individual adjusting of the storage assemblies without as such increasing costs considerably. The number of assemblies per converter is preferably reduced, for example fewer than five, which however allows better flexibility of the system, for example in case of a failure of a converter;
the output power can be predetermined and constant power, especially considered as sufficient to supply the object, or power required by the object to be supplied at each instant, measured in the installation, and therefore likely to be variable;
at least one characteristic relative to the assembly is determined as a function of said or at least one of the measured parameters, said characteristic(s) relative to an assembly being likely to being used for determining the setpoint of the converter associated to at least one other assembly. Said or at least one of the characteristics is a power level stored in the assembly and/or an admissible discharge intensity;
preferably, each assembly comprises a measuring unit for measuring the parameter(s) relative to the assembly and optionally determining means of said or at least one of the characteristics relative to the assembly. These measured parameters can in fact be used to manage other commands internal to the power storage assembly and include them in the assembly. This embodiment therefore combines functionalities and avoids extra costs;
the assembly is also controlled so that the discharge intensity of the latter does not exceed the intensity of determined admissible discharge. The control means for achieving this can be integrated to the assembly;
at least one of the assemblies, especially each assembly, is likely to transmit said or at least one of the measured parameters and/or said or at least one of the determined characteristics to a processing unit which performs the determining step of the setpoints of the converters associated to each assembly. By having all necessary data relative to the assemblies, this processing unit can easily conduct the determining step of the output setpoints associated to each assembly;
the method according to the invention can especially comprise the following steps:
   when the value of said or at least one determined parameter and/or of said or at least one determined characteristic associated to an assembly, so-called weak assembly, is comprised in a first range of predetermined values, the setpoint of the converter associated with said assembly is determined only as a function of the values of the parameter(s) and/or characteristic(s) relative to the assembly,
   for the assemblies whereof the value of the determined parameter(s) and/or the associated determined characteristic(s) is not comprised in the first range, so-called strong assemblies, the setpoints of the converter(s) associated with said assemblies are determined as a function of output power and the setpoints of the converter(s) determined for the weak assemblies;
The assemblies which store less power than expected (or weak assemblies) are therefore reported and are the only ones which benefit from particular adapted processing. They can be requested less power but in return, increased power is requested to the other assemblies. In particular, the total power to be transmitted by the assemblies is determined from which the power likely to be provided by the weak assemblies without degrading the latter is subtracted. The power determined in this way is divided by the number of strong assemblies so as to determine the power each is to provide. The setpoints of the converters are then adjusted so that each strong assembly provides the same power. This equalizes the levels of power of the different assemblies and better manages the entire system;
each assembly preferably transmits the value of the determined parameter(s) and/or of the determined characteristic(s) to the processing unit only if the value of the characteristic or of the parameter is comprised in the first range. In this way, useless communications within the system are avoided and only the weak assemblies are reported to the processing unit so that the latter can consider them. Alternatively, all the assemblies transmit their parameters, for example around every second, especially according to synchronization set up by the processing unit. In this way, data collisions are avoided;
the assembly is especially so-called “weak” if the admissible discharge intensity is less than a threshold value. The discharge intensity can be determined from the measured parameters and/or other characteristics relative to the assembly, such as the power level stored in the latter.
A particular case which can be found is the following: when the stored power level of an assembly is less than a threshold value, for example 5%, a zero admissible discharge intensity is determined for this assembly and a likewise zero setpoint of the converter associated to the assembly is then determined, i.e. for example a voltage setpoint at output is adjusted to 0V, which then disconnects the storage assembly from the rest of the electric circuit and especially from the object to be supplied. Such a zero admissible discharge intensity can also be determined when some classic alarms are reported within the storage assembly, for example if it is indicated that the temperature is less than a certain threshold or by contrast greater than a certain threshold, denoting a failure of the storage assembly;
the measured parameter(s) (within each assembly) are especially comprised in the following list:
   intensity circulating in the assembly, and/or
   voltage at the terminals of at least one part of the assembly, and/or
   temperature of the assembly;
when the value of said or at least one parameter and/or of said or at least one characteristic associated to an assembly is comprised in a second predetermined range, the setpoint of the converter associated to the assembly is determined such that non-zero power is transmitted to the assembly, the converter being bidirectional. This parameter, or this verified characteristic, can be other than that compared to the first range of values or can be the same, the second range of values then being comprised in the first range;
in particular, when the power level of an assembly is less than a threshold value, for example 1%, this assembly is controlled so that it operates in charge mode and a setpoint of the converter associated to the assembly is determined such that non-zero power is transmitted to the assembly. This avoids total discharge of the assembly. The power is transmitted to the assembly, especially obtained by transmitting a voltage setpoint from the associated converter to this assembly, greater than the nominal voltage of the assembly, which charges the assembly. This assembly can be charged at low intensity from the other storage assemblies, the other assemblies however remaining in discharge mode;
each power storage assembly is especially a battery module comprising at least one elementary cell, especially a plurality of elementary cells in series. Each cell includes an anode, a cathode and an electrolyte, the anode and the cathode exchanging ions by means of the electrolyte so that a redox reaction occurs in the cell. The battery module is preferably of lithium metal polymer type with an electrolyte made of polymer and solid when the battery module is at rest. This configuration in fact increases the safety of the battery module and its service life;
the power storage assemblies are connected to at least one power source, by means of the converter(s), said converter(s) being bidirectional, the method comprising a step for controlling the converters and assemblies for switching from the discharge phase to a charge phase. The charge phase in fact stores power in the storage assemblies and is therefore very important;
switching from the discharge phase to the charge phase is carried out when it is measured that input power provided by the electrical source is greater than a threshold power, especially the output power. This is especially the case when the power source is power generation means which does not supply DC power but depends, for example for this, on weather conditions;
during the charge phase:
   power provided by the electrical source is measured and it is determined if the available power is sufficient for charging the assemblies at an intensity of predetermined charge, and
   if this is the case, a setpoint of the converter(s) associated to each assembly is determined, selected to charge each assembly at intensity of predetermined charge,
   if not, a setpoint of the converter(s) associated to each assembly is determined, selected so as to charge each assembly at the same power and at least one magnitude of charge of the assembly is determined, especially an admissible charge intensity, as a function of this setpoint;
In this charge phase, as explained earlier, the voltage setpoint of the converter is especially adjusted to be greater than the voltage of the power storage assembly. Here too, the setpoint of the converter is adjusted as a function of the electrical element which receives the power specifically from the storage assembly. When sufficient power is available, only the parameters of the assembly can be considered for determining the associated setpoint.

However, if the power source is not sufficiently powerful, equal charging of each of the assemblies is performed at low current rather than charging just some, which homogenizes the system and increases its service life;
the power storage assemblies can be connected to two separate power sources, especially via the DC bus, one of the power sources being especially a power generation means while the other of the sources is a power distribution network. The main power source is preferably the power generation means, and the assemblies (and the object to be supplied) are connected to the other power source when the input power provided by the main source and the power provided by the assemblies in discharge phase is less than a threshold power, especially the output power. This optimizes use of the installation since the objects to be supplied could still be supplied, at least by means of the backup power network. This backup power network is however connected only when this is really necessary to the assemblies and/or the object to be supplied.

Another aim of the invention is a system for providing power to an object to be supplied, the system comprising a plurality of power storage assemblies intended to provide power to the object to be supplied in a discharge phase, the storage assemblies being electrically connected in parallel, at least one DC converter being interposed between the power storage assemblies and the object to be supplied, such that the power originating from each storage assembly is converted independently of that originating from the other assemblies, the system also comprising:
measuring means of at least one parameter relative to each storage assembly,
determining means of a setpoint relative to an electrical magnitude associated to each of the assemblies at output of the converter(s) as a function of the parameters measured by all the measuring means and of output power relative to the object to be supplied,
control means of said or each converter so that the respective setpoints are applied to the converters.

As already indicated, a converter can be placed in series with each power storage assembly or be interposed between a plurality of storage assemblies and the object to be supplied. Regardless, the converter is all the same capable of applying a different setpoint for each of the assemblies to which it is electrically connected.

The measuring means are preferably arranged at each assembly, the system also comprising a processing unit capable of communicating with all the assemblies and comprising the determining means of the setpoint associated to each assembly.

In this case, the processing unit is preferably also capable of communicating with the control means of the converter(s).

The power storage assemblies can be connected to at least one power source, by means of the converter(s), said converter(s) being bidirectional. The power storage assemblies can be charged or discharged by means of the converter(s).

Optionally, the power storage assemblies are connected to two separate power sources, one of the power sources being especially a power generation means while the other of the sources is a power distribution network.

The system can of course also comprise the one or more characteristics defined above in relation to the method.

A non-limiting embodiment of the invention will now be described by means of the figures detailed hereinbelow, in which:

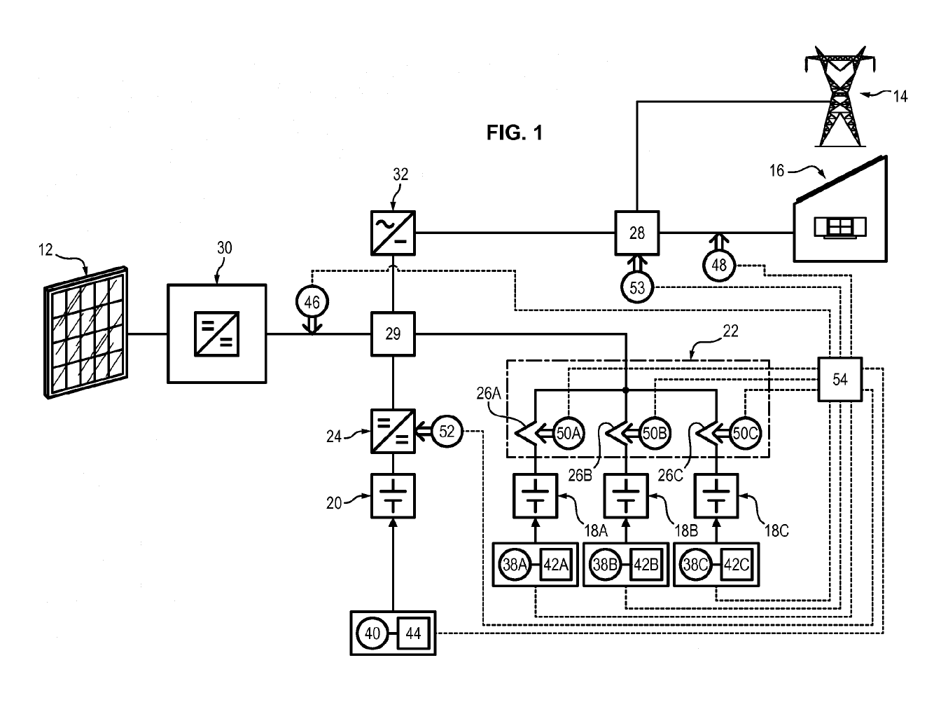

FIG. 1 is a simplified electrical diagram of the system according to a particular embodiment of the invention,

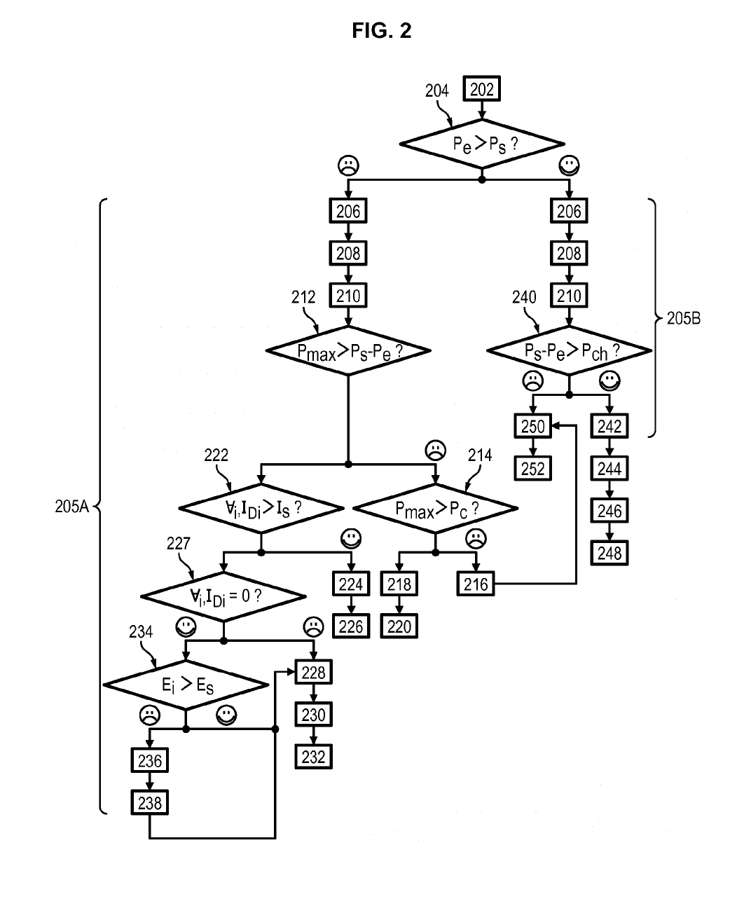

FIG. 2 is a diagram of a method for managing the system of FIG. 1 and especially of the storage assemblies according to a particular embodiment of the invention.

FIG. 1 shows a system 10 according to an embodiment of the invention.

As is evident in the figure, this system comprises two separate power sources, specifically power generation means 12 from a natural source, here represented by a photovoltaic panel, and a power distribution network 14. It is clear that the electrical power generation means 12 of course comprises in reality, when the power is of solar origin, many more than one panel, the panels able to be connected in parallel and/or in series. Of course, the power generation means could be any other means, such as wind turbine, marine turbine, etc. The power distribution network could also be replaced by an emergency power supply.

The system according to the invention also comprises an object to be supplied 16, here represented by a residence but which could be any electrical charge, irrespective of its nature and the electric power necessary to supply it. The network 14 could also be considered as an object to be supplied but this is not the case in the embodiment which is described here.

It also comprises power storage means, comprising a plurality of power storage assemblies 18A, 18B, 18C, 20, here all identical and arranged in parallel. The power storage assemblies are especially battery modules generally comprising at least one elementary cell, and preferably a plurality of elementary cells in series, each cell comprising a cathode, an anode and an electrolyte so that a redox reaction occurs within each elementary cell. The battery module is preferably of lithium type and especially of lithium metal polymer type, with an electrolyte in solid form when the battery module is at rest, which improves the safety and service life of the module. Of course, the module could however be any other type, for example lithium-ion. The modules could also not all be identical, and especially be different of type and/or have different storage capacities. The number and arrangement of the storage assemblies is not limited only to what has been described, with some assemblies for example able to be arranged in series.

The system also comprises DC converters 22 and 24, arranged in series of the storage assemblies. More particularly, the converter 22 is interposed between the storage assemblies 18A-18C on the one hand and the electrical sources 12, 14 and the object to be supplied 16 on the other hand. The converter 24 is interposed between the storage assembly 20 on the one hand and the electrical sources 12, 14 and the object to be supplied 16 on the other hand. The charge current which arrives at each of the storage assemblies (from the electrical sources) and the discharge current which is obtained from this (to supply the object 16) therefore necessarily transits via a converter. The converters are of any known type and preferably consist of choppers.

As is clear in FIG. 1, the converters 22, 24 are not of the same type. The converter 24 is intended to be arranged in series of a single power storage assembly 20 while the converter 22 is arranged upstream of three storage assemblies 18A-18C and is intended to manage the latter. For this it comprises three electrical branches in parallel, each including adjusting means for adjusting an electrical magnitude specific to this electrical branch, for example a controllable switch of the type IGBT transistor 26A-26C. In this way each storage assembly can be individually managed, even if a single converter is placed upstream of three storage assemblies.

The converters 22, 24 function as voltage generators which apply controllable predetermined voltage and which can be separated upstream of each storage assembly. Said predetermined voltage is the voltage setpoint of the converter. It is evident that the converters could be also current generators and a current setpoint could be controlled and applied. In the embodiment described, as a function of the voltage setpoint applied to each converter or to each branch of the converter, the batteries can be charged or discharged. Charging is done especially when the converter has a voltage setpoint associated to the storage assembly which is higher than the voltage of the storage assembly and discharging is done when the converter has a voltage setpoint associated to the storage assembly not as high as that of the storage assembly.

The converters are not limited to what has been described. They could in fact be placed upstream of any number of storage assemblies. A single converter could for example manage the voltage setpoints of all the storage assemblies. A separate converter could be used by a storage assembly in the extreme reverse, as is illustrated by the assembly 20. The first option allows cost saving but is not very attractive as the charge and discharge phases of the assemblies associated to the same converter must be managed jointly. A good compromise is to connect each converter to three assemblies. Evidently, this option is not the only one valid and many configurations can produce functional systems and satisfy the above aim.

As indicated earlier, the group consisting of the assemblies 18A-18C; 20 and converters 22-24 is electrically connected both the electrical sources 12, 14 and also to the object to be supplied 16. All these electrical elements are connected together via a DC bus 29 which optimally and flexibly manages electric power originating from multiples sources especially by allowing some storage assemblies to be charged while others are discharged.

The DC bus 29 is more particularly connected both to the solar panels 12 and also to the power distribution network 14 to which the object to be supplied 16 is also connected. It is also clear that interconnection means 28 are provided to connect the DC bus 29 to the network 14 and/or to the object to be supplied 16 as well as the object to be supplied 16 to the network 14.

Interposed between the electrical source 12 and the DC bus 29 on the one hand and the network 14, the object 16 and the DC bus 29 on the other hand, the system also comprises a converter, respectively 30 and 32, for adapting the electric power provided by each of the electrical sources 12, 14 to supply capable of charging the storage assemblies 18A-18C; 20. It is evident that the power storage assemblies store DC power.

The converter 30 located downstream of the photovoltaic panels 12 is especially a charger comprising a DC converter, the panels also producing DC power. The charger is especially of MPPT type (Maximum Power Point Tracking) in which the converter adapts its voltage setpoint as a function of the power produced by the panels when it applies this setpoint, these panels being non-linear generators which does not produce the same power as a function of the voltage at which they generate electric power. The converter is of course adapted to the electrical source, a converter downstream of a wind turbine which produces AC current would for example be an AC/DC converter or a rectifier.

The converter 32 located downstream of the network 14 and to which the object to be supplied is also connected is a bilateral AC/DC converter, transforming the produced AC power into DC power and vice-versa, the network distributing the AC current and the object to be supplied also using the current in this form. It is evident that the network and the associated converter are backup power generation means which in theory would not have to be used during normal operating of the system and are present in the system only to eliminate malfunctions of some elements of this system. The system according to the invention could therefore be designed without the electrical branch comprising the network 14. As a variant, the object to be supplied can also be the general power distribution network which supplies the storage assemblies when there is a surplus of electric power relative to the power required in the network, power being returned to the network when power produced elsewhere in the network is not sufficient.

The system also comprises measuring means 38A, 38B, 38C, 40 relative to each storage assembly 18A, 18B, 18C, 20, these measuring means being intended to measure at least one parameter relative to each storage assembly. These parameters are in particular the temperature of the storage assembly, current circulating in at least one part of the assembly and/or voltage at the terminals of at least one part of the assembly. These means comprise known ad hoc sensors and are generally integrated into the power storage assembly. The parameters measured by the measuring means can be then analyzed by analysis means respectively 42A, 42B, 42C, 44 comprising especially determining means of at least one characteristic, such as a level of charge of the battery or a current discharge setpoint, from the measured parameters.

These analysis means are preferably also integrated into the power storage assembly and enable proper management of the storage assembly. They form part of an integrated element called BMS (Battery Management System) and intended to manage the storage assembly with which it is associated. Such a device especially conducts tests on measured parameters and/or characteristics determined from the measured parameters and when these tests return abnormal results they carry out actions to limit the consequences of the malfunction. For example, when the temperature of the storage assembly is not within a predetermined range, the analysis means can control interconnection means such as a fuse for disconnecting the storage assembly from the rest of the circuit. It is therefore clear that control means can be integrated into the analysis means.

As a variant, the measuring and/or analysis means could be external to the storage assembly even if it comprises an element such as a BMS, which would all the same be less advantageous in terms of costs. The analysis means are optional or could be integrated into other components of the system, especially the processing unit 54 described hereinbelow.

The system also comprises measuring means 46 located in the electrical branch of the electrical source 12 and measuring the input power which said source 12 is capable of providing. These measuring means 46 can especially comprise measuring means of the voltage and intensity in this electrical branch, especially at output of the MPPT charger 30.

It can also comprise measuring means 48 located in the electrical branch of the object to be supplied 16 and measuring the output power required by the object to be supplied. These measuring means 48 can especially comprise measuring means of the voltage and the intensity in this electrical branch. As a variant, the system cannot comprise these measuring means but the output power can be predetermined as a function of the known needs of the object to be supplied.

The system also comprises control means 50A, 50B, 50C, 52 of the converters, these control means controlling application of a predetermined voltage setpoint in association with each of the assemblies. The means 50A, 50B, 50C in particular control the adjustment means 26A, 26B, 26C each located on an electrical branch of the converter 22. The system also comprises control means 53 of the interconnection means 28.

The system also comprises a processing unit 54 in communication with all the measuring and analysis means described above. This processing unit 54 comprises especially data storage means for storing the parameters and/or characteristics it receives from the different elements of the system and execution means, such as a processor, which let them determine the voltage setpoints associated to each of the assemblies from the measured parameters and/or the determined characteristics transmitted by the power storage assemblies.

The operation of the system and especially the method 200 for managing the power storage assemblies according to an embodiment of the invention will now be described.

The respective input and output powers of the system are first measured during a step 202 by means of the respective means 46, 48. These two powers are then compared, by means of the processing unit 54 especially during a step 204. If the power provided at input Pe is less than the output power Ps, this means that the power provided by the electrical source 12 is not sufficient to supply the object to be supplied. Extra power must be obtained by means of the power storage assemblies, and the choice is made therefore to discharge the power storage assemblies to the object to be supplied. The processing unit 54 therefore sends to the power storage assemblies the setpoint for setting discharge mode (discharge phase 205A). However, if the input power Pe is greater than the output power Ps this means that the photovoltaic panels supply enough power coming from the source to supply the object 16 and that available power remains in the system. The aim therefore is to store this power and the choice is made to charge the power storage assemblies. The processing unit 54 therefore sends to the power storage assemblies the setpoint for setting charge mode (charge phase 205B).

Discharge Phase:

In the event where discharge phase is on, the respective measuring means 38A-38C, 40 of each storage assembly 18A-18C, 20 measure the parameters relative to the storage assembly, i.e. especially the temperature and voltage at the terminals of the assembly, during a step 206. The respective analysis means 42A-42C, 44 then determine some characteristics of the storage assembly, such as the charge level and the admissible discharge intensity, also called current limitation setpoint, of each storage assembly during a step 208. The analysis means 42A-42C, 44 control especially the storage assembly so that the discharge intensity does not exceed the value of the setpoint. The different parameters and characteristics are sent to the processing unit 54 during a step 210.

The processing unit 54 is therefore capable of calculating by means of current limitation voltages and setpoints of each storage assembly 18A-18C, 20 the available power at the terminals of each assembly and the maximal power Pmax which can be provided by the assemblies (sum of the power of each assembly) and this power Pmax can be compared to the power needed to supply the object 16, or (Ps−Pe), during a step 212.

If the power Pmax is not greater than (Ps−Pe), Pmax is compared to another lower threshold power so-called critical Pc, during a step 214. If the power Pmax is less than the critical power Pc, this means that the system will not be enough to supply the object 16 and the interconnection means 28 and the storage assemblies are controlled by means of the processing unit 54 and control means 53 so that the system is connected to the backup network 14. In particular, the interconnection means 28 are controlled so that the current originating from network can supply both the storage assemblies and the object to be supplied. The storage assemblies can also be supplied by the solar panels. The storage assemblies are also controlled by the respective analysis means 42A-42C, 44 for switching to charge mode.

In the opposite case, the interconnection means 28 are controlled such that the object to be supplied is connected to the DC bus 29 and optionally to the network 14 but the DC bus 29 is not connected to the network 14.

If the power Pmax is greater than Pc, it is considered that the system can supply the object to be supplied but that the maximal power of each of the assemblies must be used and, during a step 218, the processing unit 54 determines the voltage setpoints associated to each of the assemblies as a function only of the characteristics of the assemblies, specifically so that the corresponding assembly discharges at the admissible discharge intensity to the object to be supplied 16. The converters 22, 24 are then controlled during a step 220 for applying the determined setpoints by means of the means 50A-50C, 52. Of course, the voltage setpoints will be less than the measured respective voltages of the storage assemblies, given that these assemblies are in discharge mode.

If on the contrary the power Pmax is greater than (Ps−Pe), the processing unit 54 verifies for each of the assemblies 18A-18C, 20 if the current limitation setpoint I_{D18A}, I_{D18B}, I_{D18C}, I_{D20} is greater than a threshold value Is, during a step 222. If this is the case, it is considered that each storage assembly is functioning normally. The aim is to apply uniform discharge of all the assemblies. The processing unit 54 calculates the voltage setpoints associated to each of the assemblies to be applied to the converters 22, 24 to achieve this result. The setpoints associated to each of the assemblies 18A-18C, 20 are especially the same. During a step 226, the control means 50A-50C, 52 apply these setpoints to the converters.

If however the current limitation setpoint associated to one or more storage assemblies is less than the threshold value Is, these assemblies being so-called “weak”, these assemblies are spared to avoid deteriorating. A particular case is when the analysis means of the assembly determine that the current limitation setpoint is 0 A, especially because the charge level of the assembly is less than 5%. During a step 227 the processing unit tests whether the current limitation setpoint associated to a given assembly is zero.

If this is not the case, the processing unit 54 calculates, during a step 228 for each of these “weak” assemblies, a voltage setpoint associated to the latter which is only a function of the characteristics of the assembly, such that said assembly discharges at a current corresponding to its admissible discharge current. During a step 230, it then calculates the power yet to be distributed (Ps−Pe−power provided by each of the weak assemblies), and the voltage setpoint associated with the assemblies not identified as “weak” is calculated such that each of the non-“weak” assemblies supplies the same power. The setpoints of the non-“weak” assemblies are therefore equal and catch up the failures of the weak assemblies. During a step 232, the control means 50A-50C, 52 apply these determined setpoints to the converters.

If one of the “weak” assemblies however has sent a zero current limitation setpoint to the unit during a step 234, the processing unit 54 verifies whether the power stored Ei in the relevant “weak” assembly is less than a threshold power Es, for example power of 1%. If this is not the case, steps 228 to 232 are applied, the assembly having a zero current limitation setpoint by value of its admissible discharge intensity being disconnected from the object to be supplied. A zero voltage setpoint is also applied to the converter in association with the relevant assembly. It is evident that the current setpoint is applied to the assembly once the voltage setpoint has been applied to the converter.

If however, the power Ei of the storage assembly is less than the threshold power Es, it is preferable to charge it at very weak current to avoid it discharging completely. During a step 236 the unit controls switching of the corresponding storage assembly to the charge phase by means of analysis means of the assembly while the other assemblies remain in discharge phase. It also determines a voltage setpoint associated to this assembly for obtaining its charge at the required current and calculates the power generated by the charge during a step 238. It then performs steps 228 to 232 by calculating that the power remaining to be distributed is increased by the power used to maintain the assembly charged.

This method is applied in real time throughout the discharge phase: the current limitation setpoints originating from the assemblies are likely to be modified during discharge, and the setpoints transmitted to the converters are also modified as a consequence.

Charge Phase:

If during the initial test step 204, it is determined that the assemblies 18A-18C, 20 must be in charge mode, measuring, determination and transmission steps 206 to 210 already indicated in discharge phase are performed.

During a step 240, it is tested from the data obtained during steps 202, 206 and 208, whether the power dedicated to charging the assemblies (Ps−Pe) is greater than a charge power Pch corresponding to charging of all the assemblies at nominal intensity. The power Pch is also determined by means of information relative to the voltage of each assembly.

If this power is not greater than the charge power, the setpoints associated to each assembly at the converters are determined such that charging of the assemblies is achieved uniformly and the power is distributed evenly over the different assemblies during a step 242. The control means 50A-50C, 52 are controlled during a step 244 so that they apply said setpoint. The setpoint transmitted to the converter is also transmitted, during a step 246, to each assembly and each assembly adapts, by means of its analysis means 42A-42C, 44, the current charge limitation setpoint applied to the assembly, during a step 248.

If the available power for charging the assemblies 18A-18C, 20 is however greater than the charge power, charging is done conventionally, i.e. a voltage setpoint is determined by the processing unit 54 only as a function of the characteristics of the assembly, especially such that the assembly is charged at the nominal current, during a step 250. Then during a step 252, the converters 22, 24 are controlled by means of the control means 50A-50C, 52 to apply the setpoints calculated by the processing unit.

As indicated above, in this charge phase the voltage setpoints applied in association with a storage assembly are necessarily higher than the voltage of the assembly.

If the electric power comes from the network 14, it is considered that the available power is necessarily greater than the charge power and the switch is made from step 216 directly to step 250.

In this way, the method such as described is adapted to the dispersions of the power storage assemblies so as to prolong the life of the storage assemblies even when they work together with other assemblies.

The method is not however limited to what has been described. Many steps are optional, such as the verification step of the charge level of the storage assembly. The powers selected for the thresholds can also be different to what has been indicated. Some steps can also vary as a function of the configuration of the system, for example if the determination means are integrated into the processing unit and not the storage assembly. The assembly could also transmit to the processing unit the current limitation setpoint only when it is less than a certain limit.

Many other modifications not described in the application can also form part of the invention, since these modifications enter the scope of the claims.

1. A method (200) for managing a plurality of power storage assemblies (18A-18C, 20) intended to provide electric power to an object to be supplied (16) during a discharge phase (205A), the storage assemblies being electrically connected in parallel, at least one DC converter (22, 24) being interposed between the power storage assemblies and the object to be supplied, such that the power originating from each storage assembly is converted independently of that originating from the other assemblies, the method being characterized in that during the discharge phase:
at least one parameter relative to each storage assembly is measured (206),
as a function of the parameters measured for all the assemblies and of at least one output power relative to the object to be supplied, at least one setpoint relative to an electrical magnitude respective at output is determined (218, 224, 228, 230) for said or each converter, such that a separate setpoint is associated to each of the assemblies,
the converter(s) are controlled (220, 226, 232) so that the corresponding setpoint is applied.

2. The method (200) according to the preceding claim, wherein at least one converter (22) comprises a plurality of electrical branches in parallel each connected to a power storage assembly (18A-18C), each electrical branch comprising an adjusting means (26A-26C) of the electrical magnitude specific to said branch.

3. The method (200) according to any one of the preceding claims, wherein at least one characteristic relative to the assembly is determined (208) as a function of said or at least one of the measured parameters, said characteristic(s) relative to an assembly being likely to being used for determining the setpoint at output associated to at least one other assembly.

4. The method (200) according to any one of the preceding claims, wherein said or at least one of the characteristics is a power level stored in the assembly and/or an admissible discharge intensity.

5. The method (200) according to the preceding claim, wherein the storage assembly is also controlled (208) such that its intensity does not exceed the admissible discharge intensity.

6. The method (200) according to any one of the preceding claims, wherein each assembly (18A-18C, 20) comprises a measuring unit (38A-38C, 40) for measuring the parameter(s) relative to the assembly and optionally determining means (42A-42C, 44) of said or at least one of the characteristics relative to the admissible power.

7. The method (200) according to any one of the preceding claims, wherein at least one of the assemblies (18A-18C, 20), especially each assembly, is likely to transmit (210) said or at least one of the measured parameters and/or said or at least one of the determined characteristics to a processing unit (54) which performs the determining step (216, 224, 228, 230) of the setpoints of the converters (22, 24) associated to each of the assemblies.

8. The method according to the preceding claim, wherein:
when the value of said or at least one determined parameter and/or of said or at least one determined characteristic (I_{D18A}, I_{D18B}, I_{D18C}, I_{D20}) associated to an assembly, so-called weak assembly, is comprised in a first range of predetermined values, the setpoint of the converter associated with said assembly is determined (228) only as a function of the value of the parameters and/or characteristics associated to the assembly,
for the assemblies whereof the value of the measured parameter(s) and/or the associated determined characteristic(s) is not comprised in the first range, so-called strong assemblies, the setpoints of the converter(s) associated with said assemblies are determined (230) as a function of output power and the setpoints of the converter(s) determined for the weak assemblies.

9. The method according to any one of the preceding claims, wherein the assembly is so-called weak if the admissible discharge intensity (I_{D18A}, I_{D18B}, I_{D18C}, I_{D20}) is less than a threshold value (Is).

10. The method according to any one of the preceding claims, wherein the measured parameter(s) are comprised in the following list:
intensity circulating in the assembly, and/or
voltage at the terminals of at least one part of the assembly, and/or
temperature of the assembly.

11. The method according to any one of the preceding claims, wherein, when the value of said or at least one parameter and/or of said or at least one characteristic associated to an assembly is comprised in a second predetermined range, the setpoint of the converter associated to the assembly is determined (238), such that non-zero power is transmitted to the assembly, said or each converter being bidirectional.

12. The method according to the preceding claim, wherein, when the power level of an assembly is less than a threshold value, for example 1%, this assembly is controlled so that it operates in charge mode (236) and an output setpoint of the converter associated to the assembly is determined (238) such that non-zero power is transmitted to the assembly.

13. The method according to any one of the preceding claims, wherein the power storage assemblies (18A-18C, 20) are connected to at least one power source (12, 14) by means of the converter(s) (22, 24), said converter(s) being bidirectional, the method comprising a step for controlling the converters and assemblies for switching from the discharge phase (205A) to a charge phase (205B).

14. The method according to the preceding claim, wherein switching from the discharge phase to the charge phase is carried out when it is measured that input power (Pe) provided by the electrical source is greater than a threshold power, especially the output power (Ps).

15. The method according to any one of claim 13 or 14, wherein, during the charge phase (205B):
power provided by the electrical source is measured (202) and it is determined (240) if the available power is sufficient for charging the assemblies (18A-18C, 20) at an intensity of predetermined charge, and
if this is the case, a setpoint of the converter(s) associated to each assembly is determined (250), selected to charge each assembly at an intensity of predetermined charge,
if not, a setpoint of the converter(s) associated to each assembly is determined (242), selected so as to charge each assembly at the same power and at least one magnitude of charge of the assembly is determined (248), especially an admissible charge intensity, as a function of this setpoint.

16. The method according to any one of claims 14 and 15, wherein the power storage assemblies (18A-18C, 20) are connected to two separate power sources (12, 14), one of the power sources being especially a power generation means (12) while the other of the sources is a power distribution network (14).

17. The method according to the preceding claim, wherein, the main power source being the power generation means (12), the assemblies are connected to the other power source (14) when the input power (Pe) provided by the main source and the power provided by the assemblies (Pmax) in discharge phase is less than a threshold power (Pc), especially the output power.

18. A system (10) for providing power to an object to be supplied, the system comprising a plurality of power storage assemblies (18A-18C, 20) intended to provide power to the object to be supplied (16) in a discharge phase, the storage assemblies being electrically connected in parallel, at least one DC converter (22, 24) being interposed between the power storage assemblies and the object to be supplied, such that the power originating from each storage assembly is converted independently of that originating from the other assemblies, the system also comprising:
measuring means (38A-38C, 40) of at least one parameter relative to each storage assembly,
determining means (54) of a setpoint relative to an electrical magnitude at output of the converter(s) associated to each of the assemblies as a function of the parameters measured by all the measuring means and of output power (Ps) relative to the object to be supplied,
control means (50A-50C, 52) of said or each converter (22, 24) so that the respective setpoints are applied to the converters.

19. The system according to the preceding claim, wherein the measuring means (38A-38C, 40) are arranged at each assembly (18A-18C, 20), the system also comprising a processing unit (54) capable of communicating with all the assemblies and comprising the determining means of the setpoint associated to each assembly.

20. The system according to the preceding claim, wherein the processing unit (54) is capable of communicating with the control means (50A-50C, 52) of the converters (22, 24).

21. The system according to the preceding claim, wherein the power storage assemblies (18A-18C, 20) are connected to at least one power source (12, 14), by means of the converter(s) (22, 24), said converter(s) being bidirectional.

22. The system according to the preceding claim, wherein the power storage assemblies (18A-18C, 20) are connected to two separate power sources (12, 14), one of the power sources being especially a power generation means (12) while the other of the sources is a power distribution network (14).
